(19) United States
(12) Patent Application Publication
(10) Pub. No.: US 2011/0122112 A1
(43) Pub. Date: May 26, 2011

(54) PLASMA DISPLAY AND DRIVING METHOD FOR PLASMA DISPLAY PANEL

(75) Inventors: Shunsuke Kawai, Osaka (JP); Kenji Ogawa, Osaka (JP); Shinichiro Hashimoto, Osaka (JP)

(73) Assignee: Panasonic Corporation, Osaka (JP)

(21) Appl. No.: 12/527,941

(22) PCT Filed: Mar. 28, 2008
(86) PCT No.: PCT/JP2008/000785

§ 371 Date: Aug. 20, 2009

(30) Foreign Application Priority Data
Apr. 2, 2007 (JP) 2007-096233

(51) Int. Cl. G09G 3/28; G09G 5/00

(52) U.S. Cl. 345/208; 345/60

(57) ABSTRACT

Even in a plasma display panel of large screen size and high definition, address discharge is caused stably. A plasma display device has a plasma display panel and a scan electrode driving circuit. The plasma display panel includes a discharge cell having a display electrode pair that is formed of a scan electrode and a sustain electrode. A plurality of subfields having an initializing period, an address period, and a sustain period are disposed in one field period. The scan electrode driving circuit generates an increasing first ramp voltage in the initializing period of at least one subfield in one field period, generates sustain pulse voltage that varies from a base potential to a potential for causing sustain discharge in the sustain period, and generates second ramp voltage that is increased and is dropped immediately after reaching a predetermined potential at the end of the sustain period.

### TECHNICAL FIELD

The present invention relates to a plasma display device used in a wall-hanging television (TV) or a large monitor, and a driving method of a plasma display panel.

### BACKGROUND ART

A typical alternating-current surface discharge type panel used as a plasma display panel (hereinafter referred to as “panel”) has many discharge cells between a front plate and a back plate that are faced to each other. The front plate has the following elements:
a plurality of display electrode pairs disposed in parallel on a front glass substrate; and
a dielectric layer and a protective layer for covering the display electrode pairs.
   Here, each display electrode pair is formed of a pair of scan electrode and sustain electrode. The back plate has the following elements:
a plurality of data electrodes disposed in parallel on a back glass substrate;
a dielectric layer for covering the data electrodes;
a plurality of barrier ribs disposed on the dielectric layer in parallel with the data electrodes; and
phosphor layers disposed on the surface of the dielectric layer and on side surfaces of the barrier ribs.
   The front plate and back plate are faced to each other so that the display electrode pairs and the data electrodes three-dimensionally intersect, and are sealed. Discharge gas containing xenon with a partial pressure of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The ultraviolet rays excite respective phosphors of red (R), green (G), and blue (B) to emit light, and thus provide color display.

A subfield method is generally used as a method of driving the panel. In this method, one field period is divided into a plurality of subfields, and the subfields at which light is emitted are combined, thereby performing gradation display.

Each subfield has an initializing period, an address period, and a sustain period. In the initializing period, initializing discharge is caused, a wall charge required for a subsequent address operation is formed on each electrode, and a priming particle (an excitation particle as a detonating agent for discharge) for stably causing address discharge is generated. In the address period, address pulse voltage is selectively applied to a discharge cell where display is to be performed to cause address discharge, thereby forming a wall charge (hereinafter, this operation is referred to as “address”). In the sustain period, sustain pulse voltage is alternately applied to the display electrode pairs formed of the scan electrodes and the sustain electrodes, sustain discharge is caused in the discharge cell having undergone address discharge, and a phosphor layer of the corresponding discharge cell is light-emitted, thereby displaying an image.

Of the subfield method, a driving method is disclosed. In this driving method, the initializing discharge is performed using a gradually varying voltage waveform, and the initializing discharge is selectively applied to the discharge cell having undergone sustain discharge. Thus, light emission that is not related to the gradation display is minimized, and the contrast ratio is improved.

Specifically, in the initializing period of one of a plurality of subfields, the all-cell initializing operation of causing initializing discharge in all discharge cells is performed. In the initializing period of other subfields, the selection initializing operation of causing initializing discharge in only the discharge cell having undergone sustain discharge in the adjacently previous sustain period is performed. This driving manner allows image display of sharp contrast. That is because the luminance (hereinafter referred to as “black luminance”) in a black display region depending on the light emission that is not related to the image display is determined only by weak light emission in the all-cell initializing operation (e.g. patent document 1).

Patent document 1 also describes the so-called narrow-width erasing discharge. In the narrow-width erasing discharge, the width of the final sustain pulse in the sustain period is set shorter than that of other sustain pulses, and potential difference due to the wall charge between the display electrode pairs is reduced. This narrow-width erasing discharge stabilizes the address operation in the address period of the subsequent subfield, and can achieve a plasma display device of high contrast ratio.

A technology is disclosed where, after application of a sustain pulse to a display electrode pair in a sustain period is completed, an increasing ramp voltage is applied to a sustain electrode to erase the wall charge in a discharge cell (e.g. patent document 2).

A technology is disclosed where, after application of a sustain pulse to a display electrode pair in a sustain period is completed, a ramp voltage that increases to a predetermined value and then is kept at that value for a certain period is applied to a scan electrode, and then the increasing ramp voltage is applied to a sustain electrode, thereby erasing the wall charge in a discharge cell (e.g. patent document 3).

A technology is disclosed where, after application of a sustain pulse to a display electrode pair in a sustain period is completed, an increasing ramp voltage is applied to a scan electrode and the gradient is varied according to the average luminance of a display image, thereby erasing the wall charge in a discharge cell (e.g. patent document 4).

However, the technologies of patent document 2 and patent document 3 require a circuit for generating a ramp voltage to be applied to a sustain electrode. The technology of patent document 4 requires a circuit for varying the gradient of a ramp voltage. Therefore, all the technologies require a circuit having a larger scale.

The definition of the panel has been recently increased, and hence the discharge cell has been miniaturized. In the miniaturized discharge cell, it is recognized that a phenomenon called charge loss where the wall charge becomes lost is apt to occur. When the charge loss occurs, a discharge failure occurs to degrade the image display quality or increase an applied voltage required for discharge occurrence, disadvantageously.

One of main causes of the occurrence of the charge loss is discharge variation in an address period. For example, when the discharge variation in the address period is large and strong address discharge occurs, a discharge cell to emit light can rob the wall charge from a discharge cell to emit no light in a part where the discharge cell to emit light is adjacent to the discharge cell to emit no light, and charge loss occurs.

Therefore, generating address discharge as stably as possible is important to prevent the charge loss.

Recently, the screen size and definition of the panel have been further increased, and hence the driving impedance of the panel is apt to increase. When the driving impedance increases, waveform distortion such as ringing is apt to occur in a driving waveform generated from a driving circuit of the panel. The above-mentioned narrow-width erasing discharge is intended to stabilize the address operation of a subsequent subfield. For example, when waveform distortion occurs in a driving waveform for causing the narrow-width erasing discharge, the narrow-width erasing discharge can become strong. In such a case, it is difficult to stably cause subsequent address discharge.
[Patent document 1] Japanese Patent Unexamined Publication No. 2000-242224
[Patent document 2] Japanese Patent Unexamined Publication No. 2004-348140
[Patent document 3] Japanese Patent Unexamined Publication No. 2005-141224
[Patent document 4] Japanese Patent Unexamined Publication No. 2003-5700

### SUMMARY OF THE INVENTION

The plasma display device of the present invention has the following elements:
a panel having a plurality of discharge cells including a display electrode pair that is formed of a scan electrode and a sustain electrode; and
a scan electrode driving circuit.
   A plurality of subfields having an initializing period, an address period, and a sustain period are disposed in one field period. The scan electrode driving circuit generates an increasing first ramp voltage in the initializing period in at least one subfield in one field period, and generates sustain pulse voltage that varies from a base potential to a potential for causing sustain discharge in the sustain period. The scan electrode driving circuit generates second ramp voltage that is increased and is dropped immediately after the second ramp voltage reaches a predetermined potential at the end of the sustain period.

Thus, even in the panel of large screen size and high definition, abnormal discharge is prevented in a discharge cell and the wall voltage in the discharge cell can be optimally adjusted so that the subsequent address operation can be performed stably. That is because second ramp voltage, which is up-ramp voltage for erasing discharge to be applied to a scan electrode at the end of a sustain period, is increased, and is dropped immediately after reaching voltage Vers. Therefore, the address discharge can be caused stably, so that the occurrence of a discharge failure during address can be reduced and the image display quality of the panel can be improved.

### BRIEF DESCRIPTION OF DRAWINGS

FIG. 1 is an exploded perspective view showing a structure of a panel in accordance with an exemplary embodiment of the present invention.

FIG. 2 is an electrode array diagram of the panel.

FIG. 3 is a waveform chart of driving voltage applied to each electrode of the panel in accordance with the exemplary embodiment.

FIG. 4 is a circuit block diagram of a plasma display device in accordance with the exemplary embodiment.

FIG. 5 is a circuit diagram of a scan electrode driving circuit in accordance with the exemplary embodiment.

FIG. 6 is a circuit diagram of a sustain electrode driving circuit in accordance with the exemplary embodiment.

FIG. 7 is a timing chart illustrating an example of an operation of the scan electrode driving circuit and the sustain electrode driving circuit in accordance with the exemplary embodiment.

FIG. 8 is a timing chart illustrating an example of an operation of the scan electrode driving circuit in an all-cell initializing period in accordance with the exemplary embodiment.

FIG. 9 is another example of the driving voltage waveform chart in accordance with the exemplary embodiment.

### REFERENCE MARKS IN THE DRAWINGS

1 plasma display device
10 panel
21 front plate
22 scan electrode
23 sustain electrode
24 display electrode pair
25, 33 dielectric layer
26 protective layer
31 back plate
32 data electrode
34 barrier rib
35 phosphor layer
41 image signal processing circuit
42 data electrode driving circuit
43 scan electrode driving circuit
44 sustain electrode driving circuit
45 timing generating circuit
50, 60 sustain pulse generating circuit
51, 61 electric power recovering circuit
52, 62 clamping circuit
53 initializing waveform generating circuit
54 scan pulse generating circuit
55 first Miller integrating circuit
56 second Miller integrating circuit
57 third Miller integrating circuit
Q1, Q2, Q3, Q4, Q11, Q12, Q13, Q14, Q15, Q16, Q21, Q31, Q32, Q33, Q34, Q36, Q37, Q38, Q39, QH1-QHn, QL1-QLn switching element
C1, C10, C11, C12, C21, C30, C31 capacitor
L1, L30 inductor
D1, D2, D12, D13, D21, D31, D32, D33 diode
AG AND gate
CP comparator
R10, R11, R12, R13, R14 resistor

### DETAILED DESCRIPTION OF PREFERRED EMBODIMENTS

A plasma display device in accordance with an exemplary embodiment of the present invention will be described hereinafter with reference to the accompanying drawings.

### Exemplary Embodiment

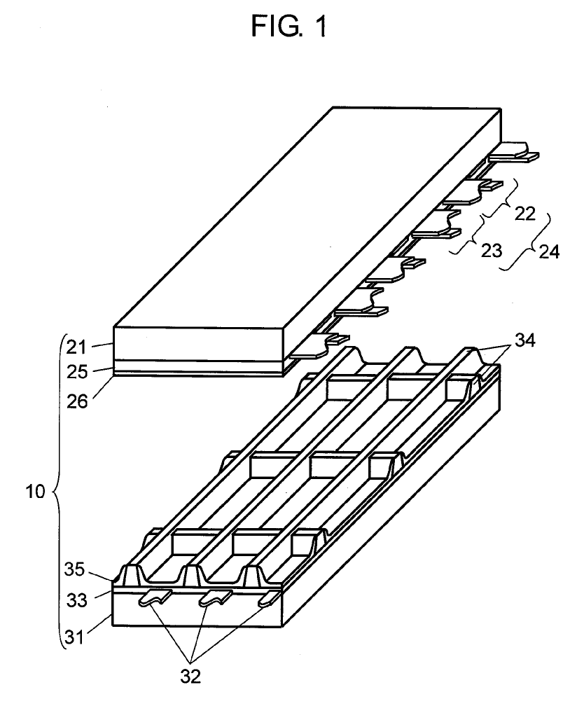

FIG. 1 is an exploded perspective view showing a structure of panel 10 in accordance with the exemplary embodiment of the present invention. A plurality of display electrode pairs 24 formed of scan electrodes 22 and sustain electrodes 23 are disposed on glass-made front plate 21. Dielectric layer 25 is formed so as to cover scan electrodes 22 and sustain electrodes 23, and protective layer 26 is formed on dielectric layer 25.

Protective layer 26 is actually used as a material of the panel in order to reduce the discharge start voltage in a discharge cell. Protective layer 26 is made of material that is mainly made of MgO and has a large secondary electron discharge coefficient and high durability when neon (Ne) and xenon (Xe) gases are filled.

A plurality of data electrodes 32 are formed on back plate 31, dielectric layer 33 is formed so as to cover data electrodes 32, and mesh barrier ribs 34 are formed on dielectric layer 33. Phosphor layers 35 for emitting lights of respective colors of red (R), green (G), and blue (B) are formed on the side surfaces of barrier ribs 34 and on dielectric layer 33.

Front plate 21 and back plate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon, for example, as discharge gas. In the present embodiment, discharge gas where xenon partial pressure is set at about 10% is employed for improving luminous efficiency. The discharge space is partitioned into a plurality of sections by barrier ribs 34. Discharge cells are formed in the intersecting parts of display electrode pairs 24 and data electrodes 32. The discharge cells discharge and emit light to display an image.

The structure of panel 10 is not limited to the above-mentioned one, but may be a structure having striped barrier ribs, for example. The mixing ratio of the discharge gas is not limited to the above-mentioned value, but may be another mixing ratio.

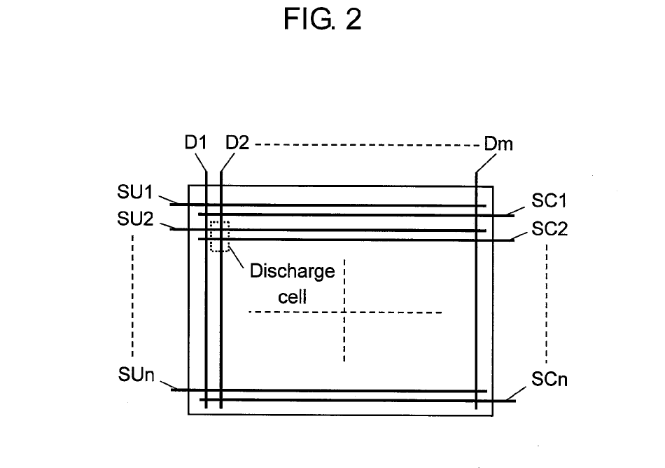

FIG. 2 is an electrode array diagram of panel 10 in accordance with the exemplary embodiment of the present invention. In panel 10, n scan electrode SC1 through scan electrode SCn (scan electrodes 22 in FIG. 1) and n sustain electrode SU1 through sustain electrode SUn (sustain electrodes 23 in FIG. 1) long in the column direction are arranged, and m data electrode D1 through data electrode Dm (data electrodes 32 in FIG. 1) long in the row direction are arranged. Each discharge cell is formed in the intersecting part of a pair of scan electrode SCi (i=1 through n) and sustain electrode SUi and one data electrode Dj (j=1 through m), the number of formed discharge cells in the discharge space is m×n. Since scan electrode SCi and sustain electrode SUi are formed in a pair in parallel as shown in FIG. 1 and FIG. 2, large inter-electrode capacity Cp exists between scan electrode SC1 through scan electrode SCn and sustain electrode SU1 through sustain electrode SUn.

Next, a driving voltage waveform and its operation for driving panel 10 are described. The plasma display device of the present embodiment performs gradation display by a subfield method. In this method, one field period is divided into a plurality of subfields, and emission and non-emission of light of each display cell are controlled in each subfield. Each subfield has an initializing period, an address period, and a sustain period.

In the initializing period in each subfield, initializing discharge is caused to produce a wall charge required for a subsequent address discharge on each electrode. The initializing operation has a function of reducing the discharge delay and generating a priming particle (an excitation particle as a detonating agent for discharge) for stably causing the address discharge. The initializing operation at this time includes an all-cell initializing operation of causing initializing discharge in all discharge cells, and a selection initializing operation of selectively causing initializing discharge only in a discharge cell that has undergone sustain discharge in the adjacently previous subfield.

In the address period, address discharge is selectively caused in a discharge cell to emit light in a subsequent sustain period, thereby producing a wall charge. In the sustain period, as many sustain pulses as the number proportional to luminance weight are alternately applied to display electrode pairs 24, and sustain discharge is caused in the discharge cell having undergone address discharge, thereby emitting light. The proportionality constant at this time is called “luminance magnification”.

In the present embodiment, one field is formed of 10 subfields (first SF, second SF, . . . , 10th SF), and respective subfields have luminance weights of 1, 2, 3, 6, 11, 18, 30, 44, 60 and 80, for example. The all-cell initializing operation is performed in the initializing period of the first SF, and the selection initializing operation is performed in the initializing period of each of the second SF through 10th SF. Thus, the light emission that is not related to the image display is only light emission caused by discharge in the all-cell initializing operation in the first SF. Therefore, black luminance, which is the luminance in a black display region where sustain discharge is not caused, is determined only by weak light emission in the all-cell initializing operation, and image display of sharp contrast is allowed. In the sustain period of each subfield, as many sustain pulses as the number derived by multiplying the luminance weight of each subfield by a predetermined luminance magnification are applied to respective display electrode pairs 24.

In the present embodiment, the number of subfields and luminance weight of each subfield are not limited to the above-mentioned values. The subfield structure may be changed based on an image signal or the like.

In the present embodiment, ramp voltage is caused at the end of the sustain period, and hence the address operation in the address period in the subsequent subfield is stabilized. First, the outline of a driving voltage waveform is described, then the configuration of the driving circuit is described.

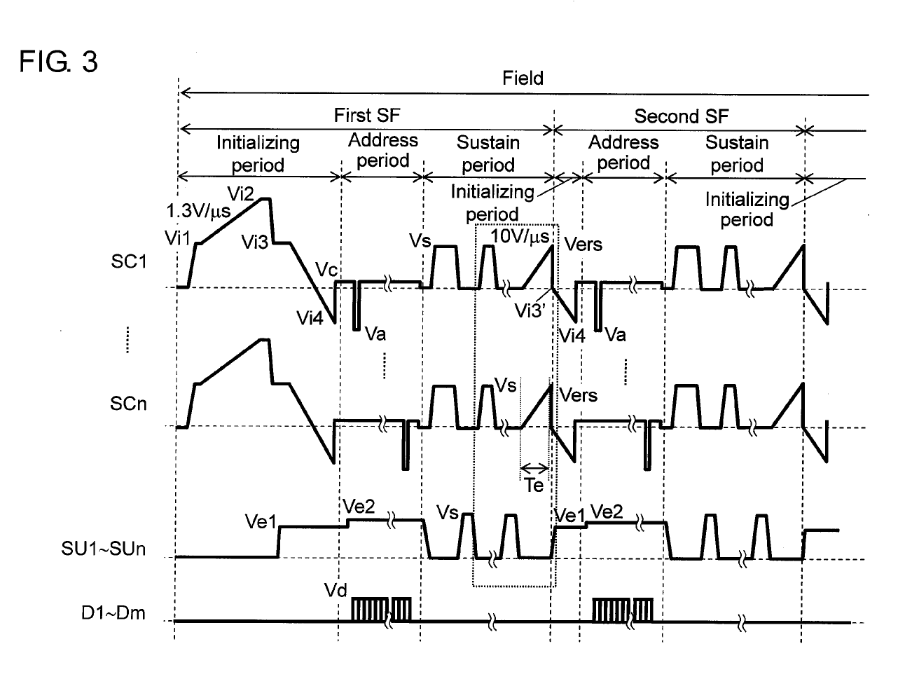

FIG. 3 is a waveform chart of driving voltage applied to each electrode of panel 10 in accordance with the exemplary embodiment of the present invention. FIG. 3 shows driving voltage waveforms of two subfields, namely a first SF and a second SF. The first SF is a subfield (hereinafter referred to as “all-cell initializing subfield”) for performing an all-cell initializing operation, and the second SF is a subfield (hereinafter referred to as “selection initializing subfield”) for performing a selection initializing operation. However, a driving voltage waveform in other subfields is substantially similar to the driving voltage waveform in the second SF. Scan electrode SCi, sustain electrode SUi, and data electrode Dk described later are selected based on image data from scan electrodes, sustain electrodes, and data electrodes, respectively.

First, a first SF as the all-cell initializing subfield is described.

In the first half of the initializing period of the first SF, 0 (V) is applied to data electrode D1 through data electrode Dm and sustain electrode SU1 through sustain electrode SUn, and a first ramp voltage (hereinafter referred to as “up-ramp voltage”) is applied to scan electrode SC1 through scan electrode SCn. Here, the up-ramp voltage gradually increases from voltage Vi1, which is not higher than a discharge start voltage, to voltage Vi2, which is higher than the discharge start voltage, with respect to sustain electrode SU1 through sustain electrode SUn. In the up-ramp voltage, the voltage difference between scan electrode SC1 through scan electrode SCn and sustain electrode SU1 through sustain electrode SUn gradually increases from voltage Vi1, which is not higher than the discharge start voltage, to voltage Vi2, which is higher than the discharge start voltage.

In the present embodiment, the gradient of the up-ramp voltage is set to about 1.3 V/μsec.

While the up-ramp voltage increases, feeble initializing discharge continuously occurs between scan electrode SC1 through scan electrode SCn and sustain electrode SU1 through sustain electrode SUn, and feeble initializing discharge continuously occurs between scan electrode SC1 through scan electrode SCn and data electrode D1 through data electrode Dm. Negative wall voltage is accumulated on scan electrode SC1 through scan electrode SCn, and positive wall voltage is accumulated on data electrode D1 through data electrode Dm and sustain electrode SU1 through sustain electrode SUn. Here, the wall voltage on the electrodes means the voltage generated by the wall charges accumulated on the dielectric layer covering the electrodes, the protective layer, and the phosphor layer.

In the last half of the initializing period, positive voltage Ve1 is applied to sustain electrode SU1 through sustain electrode SUn, and 0 (V) is applied to data electrode D1 through data electrode Dm. A ramp voltage (hereinafter referred to as “down-ramp voltage”) is applied to scan electrode SC1 through scan electrode SCn. Here, the down-ramp voltage gradually decreases from voltage Vi3, which is not higher than the discharge start voltage, to voltage Vi4, which is higher than the discharge start voltage, with respect to sustain electrode SU1 through sustain electrode SUn. In the down-ramp voltage, the voltage difference between scan electrode SC1 through scan electrode SCn and sustain electrode SU1 through sustain electrode SUn gradually decreases from voltage Vi3, which is not higher than the discharge start voltage, to voltage Vi4, which is higher than the discharge start voltage. While the down-ramp voltage decreases, feeble initializing discharge continuously occurs between scan electrode SC1 through scan electrode SCn and sustain electrode SU1 through sustain electrode SUn, and feeble initializing discharge continuously occurs between scan electrode SC1 through scan electrode SCn and data electrode D1 through data electrode Dm. The negative wall voltage on scan electrode SC1 through scan electrode SCn and the positive wall voltage on sustain electrode SU1 through sustain electrode SUn are reduced, positive wall voltage on data electrode D1 through data electrode Dm is adjusted to a value suitable for the address operation. Thus, the all-cell initializing operation of applying initializing discharge to all discharge cells is completed.

As shown in the initializing period of the second SF of FIG. 3, a driving voltage waveform where the first half of the initializing period is omitted may be applied to each electrode. In other words, voltage Ve1 is applied to sustain electrode SU1 through sustain electrode SUn, and 0 (V) is applied to data electrode D1 through data electrode Dm, a down-ramp voltage gradually decreasing from voltage Vi3′ to voltage Vi4 is applied to scan electrode SC1 through scan electrode SCn. In the discharge cell that has undergone the sustain discharge in the sustain period of the previous subfield, feeble initializing discharge occurs, and the wall voltages on scan electrode SCi and sustain electrode SUi are reduced. In the discharge cell where sufficient positive wall voltage is accumulated on data electrode Dk (k is integer 1 through m) by the adjacently previous sustain discharge, the excessive part of the wall voltage is discharged to adjust the wall voltage to be appropriate for the address operation. While, in the discharge cell where sustain discharge is not caused in the previous subfield, discharge does not occur and the wall charge at the end of the initializing period of the previous subfield is kept without variation. Such an initializing operation where the first half is omitted becomes a selection initializing operation of performing the initializing discharge in the discharge cell where sustain operation has been performed in the sustain period in the adjacently previous subfield.

In the subsequent address period, voltage Ve2 is firstly applied to sustain electrode SU1 through sustain electrode SUn, and voltage Vc is applied to scan electrode SC1 through scan electrode SCn.

Negative scan pulse voltage Va is applied to scan electrode SC1 in the first column, positive address pulse voltage Vd is applied to data electrode Dk (k is integer 1 through m), of data electrode D1 through data electrode Dm, in the discharge cell to emit light in the first column. At this time, the voltage difference in the intersecting part of data electrode Dk and scan electrode SC1 is derived by adding the difference between the wall voltage on data electrode Dk and that on scan electrode SC1 to the difference (Vd−Va) of the external applied voltage, and exceeds the discharge start voltage. Discharge thus occurs between data electrode Dk and scan electrode SC1. Since voltage Ve2 is applied to sustain electrode SU1 through sustain electrode SUn, the voltage difference between sustain electrode SU1 and scan electrode SC1 is derived by adding the difference between the wall voltage on sustain electrode SU1 and that on scan electrode SC1 to the difference (Ve2−Va) of the external applied voltage. At this time, by setting voltage Ve2 at a voltage value slightly lower than the discharge start voltage, a state where discharge does not occur but is apt to occur can be caused between sustain electrode SU1 and scan electrode SC1. Therefore, the discharge occurring between data electrode Dk and scan electrode SC1 can cause discharge between sustain electrode SU1 and scan electrode SC1 that exist in a region crossing data electrode Dk. Thus, address discharge occurs in the discharge cell to emit light, positive wall voltage is accumulated on scan electrode SC1, negative wall voltage is accumulated on sustain electrode SU1 and negative wall voltage is also accumulated on data electrode Dk.

Thus, an address operation of causing address discharge in the discharge cell to emit light in the first column and accumulating wall voltage on each electrode is performed. The voltage in the intersecting parts of scan electrode SC1 and data electrode D1 through data electrode Dm to which address pulse voltage Vd is not applied does not exceed the discharge start voltage, so that address discharge does not occur. This address operation is repeated until it reaches the discharge cell in the n-th column, and the address period is completed.

In the subsequent sustain period, positive sustain pulse voltage Vs is firstly applied to scan electrode SC1 through scan electrode SCn, and the ground potential as a base potential, namely 0 (V), is applied to SU1 through sustain electrode SUn. In the discharge cell having undergone the address discharge, the voltage difference between scan electrode SCi and sustain electrode SUi is obtained by adding the difference between the wall voltage on scan electrode SCi and that on sustain electrode SUi to sustain pulse voltage Vs, and exceeds the discharge start voltage.

Sustain discharge occurs between scan electrode SCi and sustain electrode SUi, and ultraviolet rays generated at this time cause phosphor layer 35 to emit light. Negative wall voltage is accumulated on scan electrode SCi, positive wall voltage is accumulated on sustain electrode SUi. Positive wall voltage is also accumulated on data electrode Dk. In the discharge cell where address discharge has not occurred in the address period, sustain discharge does not occur and the wall voltage at the end of the initializing period is kept.

Subsequently, 0 (V) as the base potential is applied to scan electrode SC1 through scan electrode SCn, and sustain pulse voltage Vs is applied to sustain electrode SU1 through sustain electrode SUn. In the discharge cell having undergone the sustain discharge, the voltage difference between sustain electrode SUi and scan electrode SCi exceeds the discharge start voltage. Therefore, sustain discharge occurs between sustain electrode SUi and scan electrode SCi again, negative wall voltage is accumulated on sustain electrode SUi, and positive wall voltage is accumulated on scan electrode SCi. Hereinafter, similarly, as many sustain pulses as the number derived by multiplying the luminance weight by luminance magnification are alternately applied to scan electrode SC1 through scan electrode SCn and sustain electrode SU1 through sustain electrode SUn to cause potential difference between the electrodes of display electrode pairs 24, thereby continuing sustain discharge in the discharge cell where the address discharge has been caused in the address period.

At the end of the sustain period, a second ramp voltage (hereinafter referred to as “erasing ramp voltage”) is applied to scan electrode SC1 through scan electrode SCn. Here, the erasing ramp voltage gradually increases from 0 (V) as the base potential to voltage Vers. Thus, feeble discharge is continuously caused, and a part or the whole of the wall voltages on scan electrode SCi and sustain electrode SUi is erased while positive wall voltage is left on data electrode Dk.

Specifically, sustain electrode SU1 through sustain electrode SUn are returned to 0 (V), then the erasing ramp voltage is generated in a gradient steeper than that of the up-ramp voltage as the first ramp voltage, for example gradient of about 10 V/μsec, and is applied to scan electrode SC1 through scan electrode SCn. Here, the erasing ramp voltage is the second ramp voltage that increases from 0 (V) as the base potential to voltage Vers exceeding the discharge start voltage, as discussed above. Then, feeble discharge occurs between sustain electrode SUi and scan electrode SCi in the discharge cell having undergone the sustain discharge. This feeble discharge is continuously caused while the voltage applied to sustain electrode SU1 through sustain electrode SUn increases. Immediately after the increasing voltage reaches voltage Vers as a predetermined voltage, the voltage applied to scan electrode SC1 through scan electrode SCn is decreased to 0 (V) as the base potential.

At this time, charged particles generated by the feeble discharge are always accumulated on sustain electrode SUi and scan electrode SCi to form wall charge so as to reduce the voltage difference between sustain electrode SUi and scan electrode SCi. Thus, while positive wall charge is left on data electrode Dk, the wall voltage between scan electrode SC1 through scan electrode SCn and sustain electrode SU1 through sustain electrode SUn is decreased to the extent of the difference between the voltage applied to scan electrode SCi and the discharge start voltage, namely (voltage Vers−discharge start voltage). The last discharge in the sustain period caused by the erasing ramp voltage is called “erasing discharge”.

In the present embodiment, immediately after the voltage applied to scan electrode SC1 through scan electrode SCn reaches predetermined voltage Vers, the voltage is dropped to 0 (V) as the base potential. It is experimentally recognized that abnormal discharge is apt to occur in the discharge cell establishing the three following conditions when the increasing voltage reaches voltage Vers and then the voltage is kept. The three conditions are described below:

1. the discharge cell itself is a discharge cell where light is not emitted (address has not performed in the subfield);

2. its adjacent cell is a discharge cell where light is emitted (address has been performed in the subfield); and

3. the discharge cell itself has undergone sustain discharge in the adjacently previous subfield.

This abnormal discharge induces false discharge in the subsequent address period, so that it is preferable to minimize occurrence of the abnormal discharge.

In the present embodiment, in generating the erasing ramp voltage, immediately after the voltage to be applied to scan electrode SC1 through scan electrode SCn reaches voltage Vers, the voltage is dropped to 0 (V) as the base potential. Therefore, the priming particles generated by erasing discharge can be immediately converged (the priming particles formed in the discharge space can be fixed as wall charge in a discharge cell). While, a time interval occurs until the priming particles generated by erasing discharge are converged in the structure where, after the voltage to be applied to scan electrode SC1 through scan electrode SCn reaches voltage Vers, the voltage is kept for a certain period. In other words, the structure of the present embodiment allows the wall charge to be in a stabler state comparing with the latter structure, and can stably generate the initializing discharge after that, especially the initializing discharge performed by the selection initializing operation using the down-ramp voltage. Therefore, the structure of the present embodiment can prevent occurrence of the abnormal discharge in the initializing period, and simultaneously can optimally adjust the wall voltage in the discharge cell so as to allow the subsequent address operation to be stably performed.

The operation of the subsequent subfield is substantially similar to the above-mentioned operation except for the number of sustain pulses in the sustain period, and is not described. The outline of the driving voltage waveform to be applied to each electrode of panel 10 of the present embodiment has been described.

In the present embodiment, the voltage value of voltage Vers is set at sustain pulse voltage Vs+3 (V), for example about 213 (V). However, preferably, the voltage value of voltage Vers is set in a voltage range between sustain pulse voltage Vs−10 (V) and sustain pulse voltage Vs+10 (V) inclusive. When the voltage value of voltage Vers is set to be larger than the upper limit, the adjustment of the wall voltage is excessive. When the voltage value is set to be smaller than the lower limit, the adjustment of the wall voltage is insufficient. Therefore, sometimes, the subsequent address operation cannot be stably performed.

The gradient of the erasing ramp voltage is set at about 10 V/μsec in the present embodiment; however, preferably, the gradient is set to be between 2 V/μsec and 20 V/μsec inclusive. When the gradient is set to be steeper than the upper limit, the discharge for adjusting the wall voltage does not become feeble. When the gradient is set to be gentler than the lower limit, the discharge becomes excessively feeble. Therefore, sometimes, the wall voltage cannot be sufficiently adjusted.

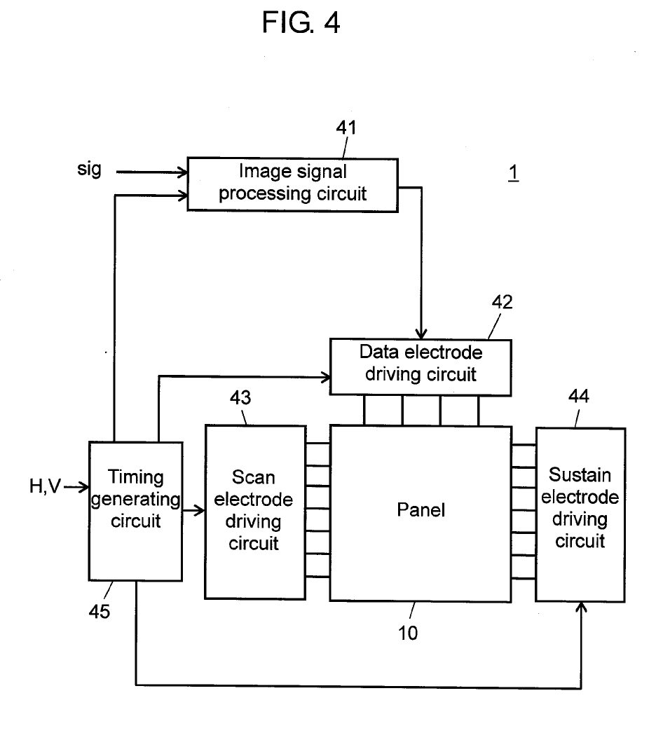

Next, a configuration of the plasma display device of the present embodiment is described. FIG. 4 is a circuit block diagram of the plasma display device of the present embodiment of the present invention.

Plasma display device 1 has the following elements:
panel 10;
image signal processing circuit 41;
data electrode driving circuit 42;
scan electrode driving circuit 43;
sustain electrode driving circuit 44;
timing generating circuit 45; and
a power supply circuit (not shown) for supplying power required for each circuit block.

Image signal processing circuit 41 converts input image signal sig into image data that indicates emission or non-emission of light in each subfield. Data electrode driving circuit 42 converts the image data in each subfield into a signal corresponding to each of data electrode D1 through data electrode Dm, and drives each of data electrode D1 through data electrode Dm.

Timing generating circuit 45 generates various timing signals for controlling operations of respective circuit blocks based on horizontal synchronizing signal H and vertical synchronizing signal V, and supplies them to respective circuit blocks. In the present embodiment, as discussed above, the timing generating circuit generates erasing ramp voltage at the end of the sustain period, and outputs a timing signal responsive to the erasing ramp voltage to scan electrode driving circuit 43 and sustain electrode driving circuit 44. Thus, stable initializing discharge is achieved and the initializing luminance of the panel is reduced.

Scan electrode driving circuit 43 has the following elements:
an initializing waveform generating circuit (not shown) for generating initializing waveform voltage to be applied to scan electrode SC1 through scan electrode SCn in the initializing period;
a sustain pulse generating circuit (not shown) for generating a sustain pulse to be applied to scan electrode SC1 through scan electrode SCn in the sustain period; and
a scan pulse generating circuit (not shown) for generating scan pulse voltage to be applied to scan electrode SC1 through scan electrode SCn in the address period.
   Scan electrode driving circuit 43 drives each of scan electrode SC1 through scan electrode SCn based on the timing signal. Sustain electrode driving circuit 44 has a sustain pulse generating circuit (not shown) and a circuit for generating voltage Ve1 and voltage Ve2, and drives sustain electrode SU1 through sustain electrode SUn based on the timing signal.

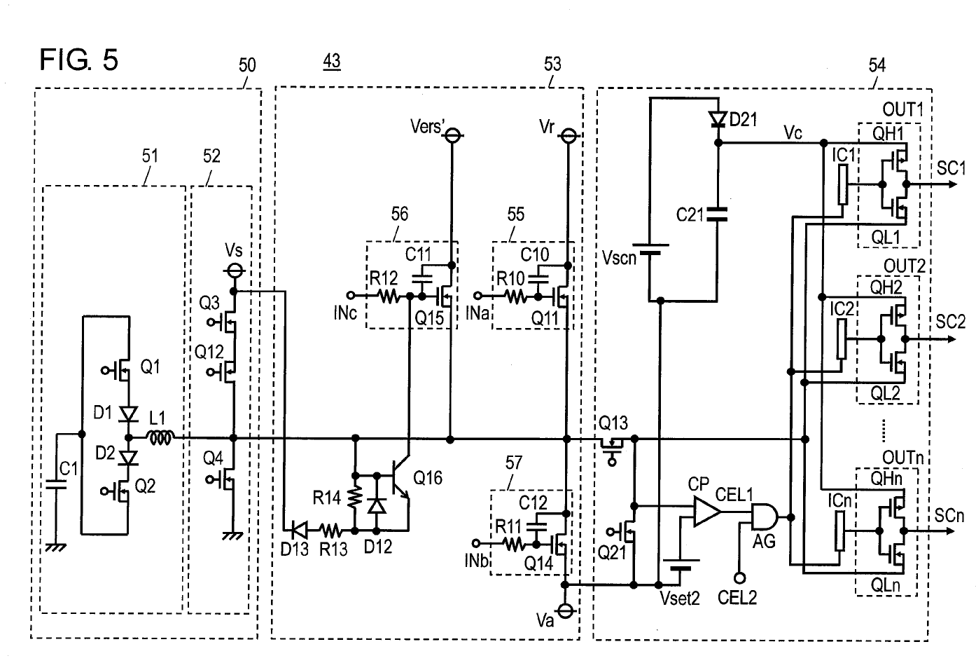

Next, scan electrode driving circuit 43 is described. FIG. 5 is a circuit diagram of scan electrode driving circuit 43 in accordance with the exemplary embodiment of the present invention. Scan electrode driving circuit 43 has sustain pulse generating circuit 50 for generating a sustain pulse, initializing waveform generating circuit 53 for generating an initializing waveform, and scan pulse generating circuit 54 for generating a scan pulse. FIG. 5 shows the following elements:
a separating circuit using switching element Q12 for electrically separating power supply voltage Vs of the sustain pulse generating circuit from initializing waveform generating circuit 53 when initializing waveform generating circuit 53 is operated; and
a separating circuit using switching element Q13 for electrically separating initializing waveform generating circuit 53 from scan pulse generating circuit 54 when a scan pulse is generated.
   In the following description, the operation of conducting a switching element is denoted with “ON”, the operation of breaking it is denoted with “OFF”, a signal for setting the switching element at ON is denoted with “Hi”, and a signal for setting the switching element at OFF is denoted with “Lo”.

Sustain pulse generating circuit 50 has electric power recovering circuit 51 and clamping circuit 52. Electric power recovering circuit 51 has capacitor C1 for recovering electric power, switching element Q1, switching element Q2, diode D1 for preventing back flow, diode D2 for preventing back flow, and inductor L1 for resonance. Capacitor C1 for recovering electric power has a capacity sufficiently larger than inter-electrode capacity Cp, and is charged up to about Vs/2, namely a half of voltage value Vs, so as to work as the power supply of electric power recovering circuit 51. Clamping circuit 52 has switching element Q3 for clamping scan electrode SC1 through scan electrode SCn on voltage Vs, and switching element Q4 for clamping scan electrode SC1 through scan electrode SCn on 0 (V). Clamping circuit 52 switches each switching element based on the timing signal output from timing generating circuit 45 and generates sustain pulse voltage Vs.

For example, in raising a sustain pulse waveform in sustain pulse generating circuit 50, switching element Q1 is set at ON to resonate inter-electrode capacity Cp and inductor L1, and electric power is supplied from capacitor C1 for recovering electric power to scan electrode SC1 through scan electrode SCn via switching element Q1, diode D1, and inductor L1. When the voltage of scan electrode SC1 through scan electrode SCn approaches Vs, switching element Q3 is set at ON, and scan electrode SC1 through scan electrode SCn are clamped on voltage Vs. Even when switching element Q12 is at OFF, a parasitic diode called a body diode is produced in an anti-parallel in a part for performing a switching operation in a metal oxide semiconductor field effect transistor (MOSFET). Here, the anti-parallel state means that the parasitic diode is produced in parallel with the part for performing the switching operation so that the forward direction of the parasitic diode is the reverse direction to the direction of current flowing by the switching operation. Therefore, by setting switching element Q3 at ON, scan electrode SC1 through scan electrode SCn can be clamped on voltage Vs via the body diode.

While, in falling a sustain pulse waveform, switching element Q2 is set at ON to resonate inter-electrode capacity Cp and inductor L1, and electric power is recovered from inter-electrode capacity Cp to capacitor C1 for recovering electric power through inductor L1, diode D2, and switching element Q2. When the voltage of scan electrode SC1 through scan electrode SCn approaches 0 (V), switching element Q4 is set at ON, and scan electrode SC1 through scan electrode SCn are clamped on voltage 0 (V).

In the present embodiment, in addition to a ramp waveform generating circuit for generating up-ramp voltage during initializing operation, a ramp waveform generating circuit for generating erasing ramp voltage is disposed. Specifically, initializing waveform generating circuit 53 has the following elements:
first Miller integrating circuit 55 as the first ramp waveform generating circuit that has capacitor C10 and resistor R10 and generates up-ramp voltage gradually increasing like a ramp to voltage Vi2;
second Miller integrating circuit 56 as the second ramp waveform generating circuit that has capacitor C11 and resistor R12 and generates erasing ramp voltage gradually increasing like a ramp to voltage Vers; and
third Miller integrating circuit 57 as the third ramp waveform generating circuit that has switching element Q14, capacitor C12, and resistor R11 and generates down-ramp voltage gradually decreasing like a ramp to voltage Vi4.
   In FIG. 5, respective input terminals of respective Miller integrating circuits are input terminal INa, input terminal INb, and input terminal INc.

The plasma display device of the present embodiment has a switching circuit. The switching circuit, in order to accurately stop the voltage increase during the generation of the erasing ramp voltage at voltage Vers, compares the erasing ramp voltage with a predetermined voltage, and stops the operation of the second Miller integrating circuit immediately after the erasing ramp voltage reaches a predetermined potential. Specifically, the plasma display device has diode D13 for preventing back flow, resistor R13 for adjusting the voltage value of voltage Vers, switching element Q16 for setting input terminal INc of second Miller integrating circuit 56 at “Lo” when the voltage output from initializing waveform generating circuit 53 reaches voltage Vers, diode D12 for protection, and resistor R14.

Switching element Q16 is formed of a generally used NPN transistor, and its base is connected to an output part of initializing waveform generating circuit 53, and its collector is connected to input terminal INc of second Miller integrating circuit 56, and its emitter is connected to voltage Vs via resistor R13 and diode D13 that are interconnected in series. The resistance value of resistor R13 is set so as to set switching element Q16 at ON when the voltage output from initializing waveform generating circuit 53 reaches voltage Vers. Therefore, when the voltage output from initializing waveform generating circuit 53 reaches voltage Vers, switching element Q16 is set at ON. Then, the current input to input terminal INc in order to operate second Miller integrating circuit 56 is extracted by switching element Q16, so that second Miller integrating circuit 56 stops operating.

Generally, in a Miller integrating circuit, the gradient of a generated ramp waveform is apt to be affected by variation of elements constituting the circuit itself. Therefore, when the waveform is generated only in the operation period of the Miller integrating circuit, the maximum voltage value of the ramp waveform is apt to vary. In the present embodiment, it is recognized to be preferable that the maximum voltage value of erasing ramp voltage is kept within a target voltage value ±3 (V). In other words, by using the configuration of the present embodiment, the maximum voltage value of erasing ramp voltage can be kept within the target voltage value ±1 (V), and the erasing ramp voltage can be accurately generated.

It is preferable to set voltage Vers′ at a voltage value higher than voltage Vers. In the present embodiment, voltage Vers′ is set at voltage Vs+30 (V). In the present embodiment, the resistance value of resistor R13 is set so that voltage Vers becomes voltage Vs+3 (V). Specifically, resistor R13 is set at 100Ω, a voltage Vs is set at 210 (V), and resistor R14 is set at 1 kΩ. However, these values are just values set based on a 42-inch panel having 1080 display electrode pairs, and are preferably set at optimal values in response to the characteristic of the panel and the specification of the plasma display device.

Initializing waveform generating circuit 53 generates the above-mentioned initializing waveform voltage or erasing ramp voltage based on the timing signal output from timing generating circuit 45.

For example, when up-ramp voltage is generated in the initializing waveform, a predetermined constant current is input to input terminal INa and input terminal INa is set at “Hi”. Constant current then flows from resistor R10 toward capacitor C10, the source voltage of switching element Q11 increases like a ramp, and the output voltage of scan electrode driving circuit 43 also starts to increase like a ramp.

When down-ramp voltage is generated in the initializing waveform in the all-cell initializing operation and selection initializing operation, a predetermined constant current is input to input terminal INb and input terminal INb is set at “Hi”. Constant current then flows from resistor R11 toward capacitor C12, the drain voltage of switching element Q14 decreases like a ramp, and the output voltage of scan electrode driving circuit 43 also starts to decrease like a ramp.

When erasing ramp voltage is generated at the end of the sustain period, a predetermined constant current is input to input terminal INc and input terminal INc is set at “Hi”. Constant current then flows from resistor R12 toward capacitor C11, the source voltage of switching element Q15 increases like a ramp, and the output voltage of scan electrode driving circuit 43 also starts to increase like a ramp. In the present embodiment, the resistance value of resistor R12 is set to be smaller than the resistance value of resistor R10. The erasing ramp voltage as the second ramp voltage is generated so that the gradient of it is steeper than that of the up-ramp voltage as the first ramp voltage.

When the driving voltage waveform output from initializing waveform generating circuit 53 gradually increases to be higher than voltage Vers, switching element Q16 becomes ON, constant current input to input terminal INc is extracted by switching element Q16, and second Miller integrating circuit 56 stops operating. Thus, the driving voltage waveform output from initializing waveform generating circuit 53 immediately decreases to 0 (V) as the base potential. Thus, in the present embodiment, the increasing of the voltage in generating the erasing ramp voltage is accurately stopped at voltage Vers as the predetermined potential, then immediately the voltage is dropped to 0 (V) as the base potential.

Scan pulse generating circuit 54 has the following elements:
switching circuit OUT1 through switching circuit OUTn for outputting scan pulse voltage to respective scan electrode SC1 through electrode SCn;
switching element Q21 for clamping the low voltage side of switching circuit OUT1 through switching circuit OUTn on voltage Va;
control circuit IC1 through control circuit ICn for controlling switching circuit OUT1 through switching circuit OUTn; and
diode D21 and capacitor C21 for applying voltage Vc obtained by superimposing voltage Vscn on voltage Va to the high voltage side of switching circuit OUT1 through switching circuit OUTn.
   Switching circuit OUT1 through circuit OUTn have switching element QH1 through switching element QHn for outputting voltage Vc and switching element QL1 through switching element QLn for outputting voltage Va, respectively. Scan pulse generating circuit 54 sequentially generates scan pulse voltage Va to be applied to scan electrode SC1 through scan electrode SCn in the address period based on the timing signal output from timing generating circuit 45. Scan pulse generating circuit 54 outputs a voltage waveform of initializing waveform generating circuit 53 in the initializing period, and outputs a voltage waveform of sustain pulse generating circuit 50 in the sustain period, as they are.

Extremely large current flows in switching element Q3, switching element Q4, switching element Q12, and switching element Q13, so that a plurality of field effect transistors (FETs) and insulated gate bipolar transistors (IGBTs) are connected to these switching elements in parallel to reduce the impedance.

Scan pulse generating circuit 54 has AND gate AG for performing logical product operation, and comparator CP for comparing between magnitudes of input signals input to two input terminals. Comparator CP compares voltage (Va+Vset2) obtained by superimposing voltage Vset2 on voltage Va with the driving voltage waveform, and outputs “0” when the driving voltage waveform is higher than voltage (Va+Vset2), and “1” in the other cases. Two input signals, namely output signal CEL1 of comparator CP and switching signal CEL2, are input to AND gate AG. As switching signal CEL2, a timing signal output from timing generating circuit 45 can be employed, for example. AND gate AG outputs “1” when all input signals are “1”, and outputs “0” in the other cases. The output of AND gate AG is input to control circuit IC1 through control circuit ICn. When the output of AND gate AG is “0”, a driving voltage waveform is output via switching element QL1 through switching element QLn. When the output of AND gate AG is “1”, voltage Vc obtained by superimposing voltage Vscn on voltage Va is output via switching element QH1 through switching element QHn.

In the present embodiment, the first ramp waveform generating circuit, second ramp waveform generating circuit, and third ramp waveform generating circuit employ the Miller integrating circuits that use a practical FET having a relatively simple configuration. However, the waveform generating circuits are not limited to this configuration, and may be any circuits as long as the circuits can generate up-ramp voltage and down-ramp voltage.

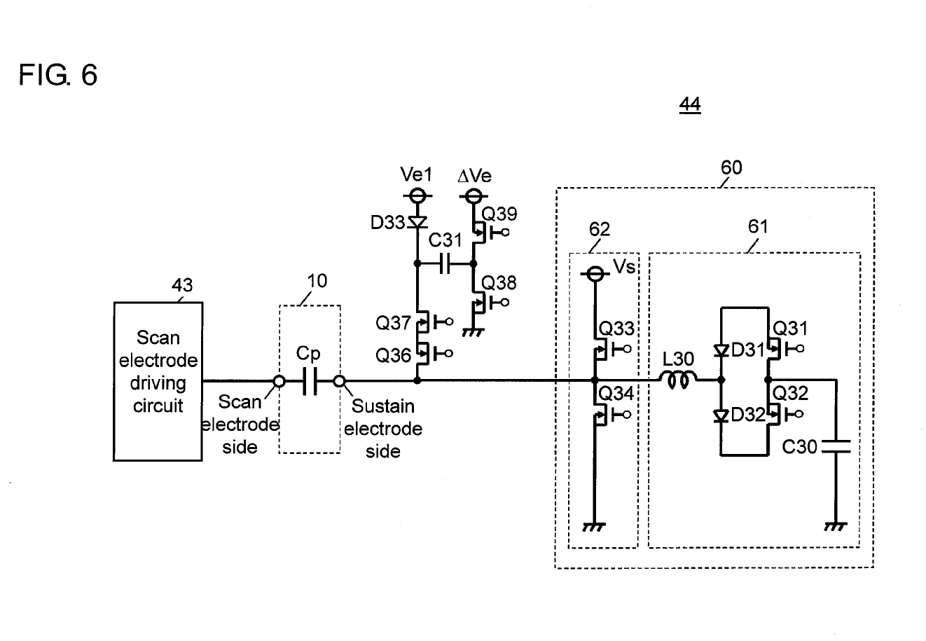

Next, sustain electrode driving circuit 44 is described. FIG. 6 is a circuit diagram of sustain electrode driving circuit 44 in accordance with the exemplary embodiment of the present invention. In FIG. 6, the inter-electrode capacity of panel 10 is denoted with Cp.

Sustain pulse generating circuit 60 of sustain electrode driving circuit 44 has a configuration substantially similar to that of sustain pulse generating circuit 50 of scan electrode driving circuit 43. In other words, sustain pulse generating circuit 60 has the following elements:
electric power recovering circuit 61 for recovering and recycling the electric power for driving sustain electrode SU1 through sustain electrode SUn; and
clamping circuit 62 for clamping sustain electrode SU1 through sustain electrode SUn on voltage Vs and 0 (V).
   Sustain pulse generating circuit 60 is connected to sustain electrode SU1 through sustain electrode SUn as one end of inter-electrode capacity Cp of panel 10.

Electric power recovering circuit 61 has capacitor C30 for recovering electric power, switching element Q31, switching element Q32, diode D31 for preventing back flow, diode D32 for preventing back flow, and inductor L30 for resonance. Inter-electrode capacity Cp and inductor L30 are LC-resonated to raise and fall the sustain pulse. Clamping circuit 62 has switching element Q33 for clamping sustain electrode SU1 through sustain electrode SUn on voltage Vs, and switching element Q34 for clamping sustain electrode SU1 through sustain electrode SUn on 0 (V). Clamping circuit 62 connects sustain electrode SU1 through sustain electrode SUn to power supply VS via switching element Q33 to clamp them on voltage Vs, and grounds sustain electrode SU1 through sustain electrode SUn via switching element Q34 to clamp them on 0 (V).

Sustain electrode driving circuit 44 has the following elements:
power supply VE1 for generating voltage Ve1;
switching element Q36 for applying voltage Ve1 to sustain electrode SU1 through sustain electrode SUn;
switching element Q37;
power supply ΔVE for generating voltage ΔVe;
diode D33 for preventing back flow;
capacitor C31 for a charge pump for adding voltage ΔVe to voltage Ve1;
switching element Q38 and switching element Q39 for adding voltage ΔVe to voltage Ve1 to generate voltage Vet.

At the timing when voltage Ve1 is applied in FIG. 3, for example, switching element Q36 and switching element Q37 are conducted, and positive voltage Ve1 is applied to sustain electrode SU1 through sustain electrode SUn via diode D33, switching element Q36, and switching element Q37.

At this time, switching element Q38 is conducted to charge capacitor C31 so that its voltage becomes voltage Ve1. At the timing when voltage Ve2 is applied in FIG. 3, for example, switching element Q38 is broken while switching element Q36 and switching element Q37 are conducted. Additionally, switching element Q39 is conducted to superimpose voltage ΔVe to the voltage of capacitor C31, and voltage (Ve1+ΔVe), namely voltage Ve2, is applied to sustain electrode SU1 through sustain electrode SUn. At this time, diode D33 for preventing back flow works to block the current from capacitor C31 to power supply VE1.

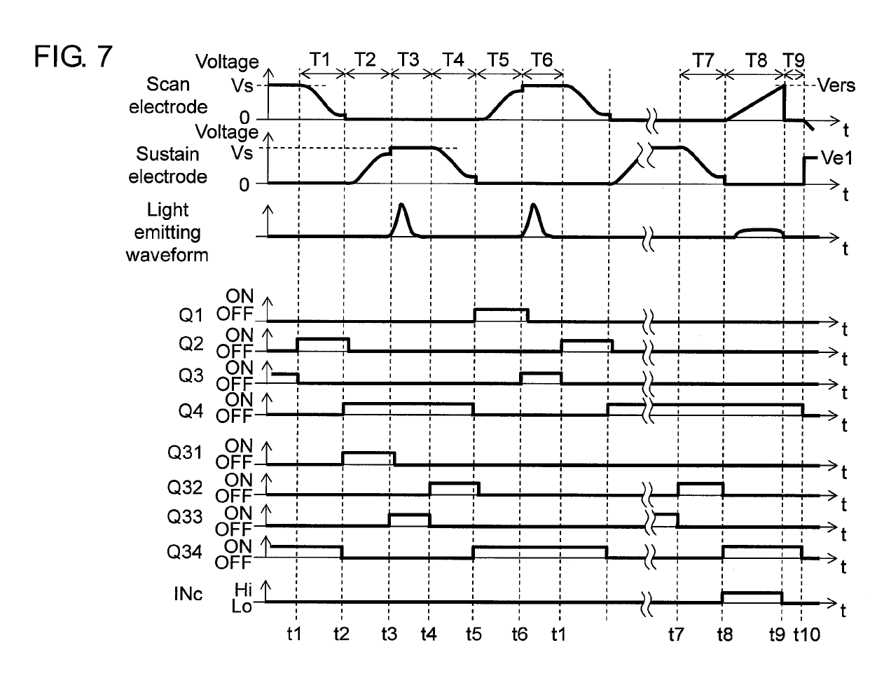

Next, the driving voltage waveform in the sustain period is described in detail. FIG. 7 is a timing chart illustrating an example of an operation of scan electrode driving circuit 43 and sustain electrode driving circuit 44 in accordance with the exemplary embodiment of the present invention. FIG. 7 is also a detailed timing chart of a part surrounded by the broken line of FIG. 3. One of repetition cycles of the sustain pulse is divided into six time periods T1 through T6, each time period is described. The repetition cycles mean intervals of the sustain pulse repeatedly applied to a display electrode pair in the sustain period, for example, show cycles repeated every time periods T1 through T6. FIG. 7 employs a positive electrode waveform, but the present invention is not limited to this. The embodiment employing a negative electrode waveform is omitted. When “raising” and “falling” in the positive electrode waveform are replaced by “falling” and “raising” in the negative electrode waveform in the following description, respectively, however, the negative electrode waveform can produce a similar effect. In the drawings, a signal for setting a switching element at ON is denoted with “ON”, and a signal for setting a switching element at OFF is denoted with “OFF”.

(Time Period T1)

Switching element Q2 is set at ON at time t1. At this time, charge on the side of scan electrode SC1 through scan electrode SCn starts to flow to capacitor C1 through inductor L1, diode D2, and switching element Q2, and the voltage of scan electrode SC1 through scan electrode SCn starts to decrease. Inductor L1 and inter-electrode large capacity Cp form a resonance circuit, so that the voltage of scan electrode SC1 through scan electrode SCn decreases to a voltage close to 0 (V) at time t2 after a lapse of ½ of the resonance period. However, due to electric power loss by resonance component or the like of the resonance circuit, the voltage of scan electrode SC1 through scan electrode SCn does not decrease to 0 (V). During this operation, switching element Q34 is kept at ON.

(Time Period T2)

Switching element Q4 is set at ON at time t2. Then, scan electrode SC1 through scan electrode SCn are directly grounded through switching element Q4, so that the voltage of scan electrode SC1 through scan electrode SCn is forcibly decreased to 0 (V).

Simultaneously, switching element Q31 is set at ON at time t2. Then, current starts to flow from capacitor C30 for recovering electric power through switching element Q31, diode D31, and inductor L30, and the voltage of sustain electrode SU1 through sustain electrode SUn starts to increase. Inductor L30 and inter-electrode large capacity Cp form a resonance circuit, so that the voltage of sustain electrode SU1 through sustain electrode SUn increases to a voltage close to Vs at time t3 after a lapse of ½ of the resonance period. Due to electric power loss by resonance component or the like of the resonance circuit, however, the voltage of sustain electrode SU1 through sustain electrode SUn does not increase to Vs.

(Time Period T3)

Switching element Q33 is set at ON at time t3. Then, sustain electrode SU1 through sustain electrode SUn are directly connected to power supply VS through switching element Q33, so that the voltage of sustain electrode SU1 through sustain electrode SUn is forcibly increased to Vs. In the discharge cell having undergone address discharge, the voltage between scan electrode SCi and sustain electrode SUi exceeds the discharge start voltage to cause sustain discharge.

(Time Periods T4 Through T6)

The sustain pulse applied to scan electrode SC1 through scan electrode SCn has the same waveform as that of the sustain pulse applied to sustain electrode SU1 through sustain electrode SUn. The operation from time period T4 to time period T6 is the same as the operation obtained by interchanging scan electrode SC1 through scan electrode SCn and sustain electrode SU1 through sustain electrode SUn in the operation from time period T1 to time period T3. Therefore, the description of it is omitted here.

Switching element Q2 is simply required to be set at OFF after time t2 before time t5, and switching element Q31 is simply required to be set at OFF after time t3 before time t4. Switching element Q32 is simply required to be set at OFF after time t5 before time t2 of the next cycle, and switching element Q1 is simply required to be set at OFF after time t6 before time t1 of the next cycle. In order to decrease the output impedance of sustain pulse generating circuit 50 and sustain pulse generating circuit 60, preferably, switching element Q34 is set at OFF just before time t2, switching element Q3 is set at OFF just before time t1, switching element Q4 is set at OFF just before time t5, and switching element Q33 is set at OFF just before time t4.

In the sustain period, the operation of time period T1 through time period T6 is repeated in response to the number of required pulses. Thus, sustain pulse voltage varying from 0 (V) as the base potential to voltage Vs as the potential for causing sustain discharge is alternately applied to display electrode pairs 24 to cause sustain discharge in the discharge cells.

Next, the operation of generating erasing ramp voltage at the end of the sustain period is described.

(Time Period T7)

The operation in this period is falling the sustain pulse that is applied to sustain electrode SU1 through sustain electrode SUn, and is the same as that in time period T4. In other words, when switching element Q33 is set at OFF just before time t7 and switching element Q32 is set at ON at time t7. Then, the charge on the side of sustain electrode SU1 through sustain electrode SUn starts to flow to capacitor C30 through inductor L30, diode D32, and switching element Q32, and the voltage of sustain electrode SU1 through sustain electrode SUn starts to decrease. Switching element Q4 is kept at ON, and scan electrode SC1 through scan electrode SCn are kept at 0 (V) as the base potential.

(Time Period T8)

Switching element Q34 is set at ON at time t8, and the voltage of sustain electrode SU1 through sustain electrode SUn is forcibly decreased to 0 (V).

Input terminal INc is set at “Hi” at time t8. Then, constant current flows from resistor R12 toward capacitor C11, the source voltage of switching element Q15 increases like a ramp, and the output voltage of scan electrode driving circuit 43 also starts to increase like a ramp more sharply than the up-ramp voltage. The erasing ramp voltage as the second ramp voltage is generated that increases from 0 (V) as the base potential to voltage Vers. While the erasing ramp voltage increases, the voltage difference between scan electrode SCi and sustain electrode SUi exceeds the discharge start voltage. At this time, each numerical value is set so as to cause discharge only between scan electrode SCi and sustain electrode SUi in the present embodiment. For example, sustain pulse voltage Vs is set at about 210 (V), voltage Vers is set at about 213 (V), and the gradient of the erasing ramp voltage is set at about 10 V/μsec. Thus, feeble discharge can be caused between scan electrode SCi and sustain electrode SUi, and this feeble discharge can be continued while the erasing ramp voltage increases.

At this time, when instantaneous strong discharge is caused by rapid voltage variation, massive charged particles generated by the strong discharge produce large wall charge so as to reduce the rapid voltage variation, and the wall voltage generated by the adjacently previous sustain discharge is excessively erased. In the panel where driving impedance are increased by large screen size and high definition, waveform distortion such as ringing is apt to occur in the driving waveform generated from a driving circuit. Therefore, strong discharge due to the waveform distortion can occur in the driving waveform for causing the above-mentioned narrow-width erasing discharge.

In the present embodiment, however, feeble erasing discharge is continuously caused between scan electrode SCi and sustain electrode SUi by the erasing ramp voltage for gradually increasing the applied voltage. Even in the panel where driving impedance are increased by large screen size and high definition, erasing discharge can be caused stably, and the wall voltage on scan electrode SCi and sustain electrode SUi can be adjusted to a state optimum for stably causing the subsequent address.

At this time, data electrode D1 through data electrode Dm are kept at 0 (V) (not shown), so that positive wall voltage is generated on data electrode D1 through data electrode Dm.

(Time Period T9)

At time t9, the driving voltage waveform output from initializing waveform generating circuit 53 reaches voltage Vers, switching element Q16 becomes ON, current input to input terminal INc in order to operate second Miller integrating circuit 56 is extracted by switching element Q16, and second Miller integrating circuit 56 stops operating.

When the voltage applied to scan electrode SC1 through scan electrode SCn reaches voltage Vers and then is kept at voltage Vers, abnormal discharge can occur to induce false discharge in the subsequent address period as discussed above. In the present embodiment, however, immediately after the voltage applied to scan electrode SC1 through scan electrode SCn reaches voltage Vers, the voltage is decreased to 0 (V) as the base potential. Therefore, the priming particles generated by erasing discharge can be immediately converged. As a result, comparing with the structure where the voltage applied to scan electrode SC1 through scan electrode SCn reaches voltage Vers and then is kept at Vers for a certain period, the present embodiment can further stabilize the wall charge state and can stably cause the subsequent initializing discharge, especially the initializing discharge by selection initializing operation using a down-ramp waveform. In other words, this abnormal discharge can be prevented from occurring in the initializing operation.

After time t10 in the initializing period of the subsequent subfield, the initializing operation of the subsequent subfield is started. For example, when the subsequent subfield is a selection initializing subfield, down-ramp voltage is applied to scan electrode SC1 through scan electrode SCn, voltage Ve1 is applied to the sustain electrode SU1 through sustain electrode SUn, and the selection initializing operation is started.

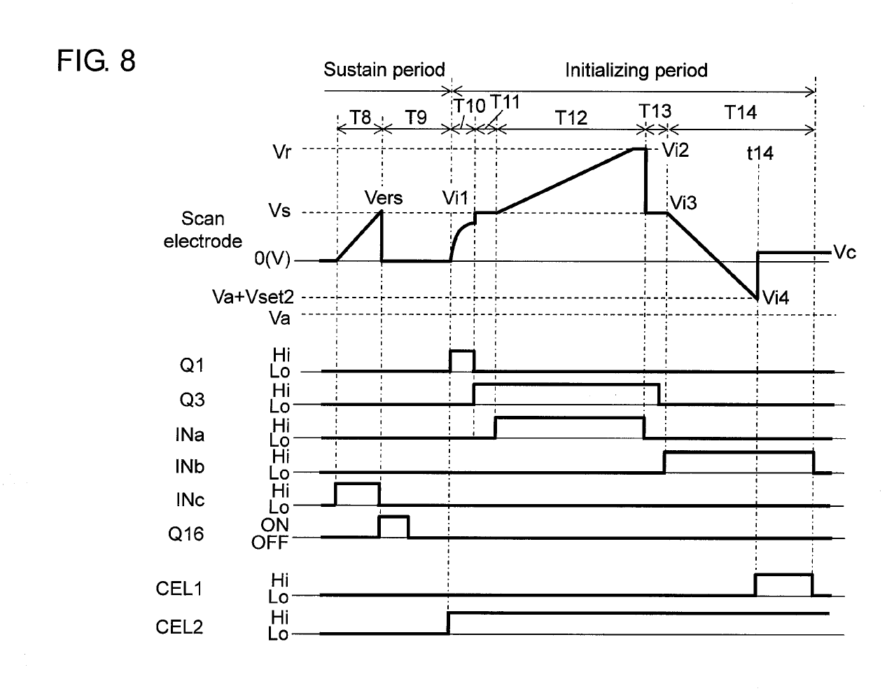

Next, a driving voltage waveform in an initializing period is described in detail. FIG. 8 is a timing chart illustrating an example of an operation of scan electrode driving circuit 43 in an all-cell initializing period in accordance with the exemplary embodiment of the present invention. This drawing describes a driving waveform in the all-cell initializing period as an example, but down-ramp voltage can be generated also in a selection initializing period by similar control.

In FIG. 8, the driving voltage waveform for performing all-cell initializing operation is divided into five time periods T10 through T14, and each time period is described. It is assumed that voltage Vi1 and voltage Vi3 are equal to voltage Vs, voltage Vi2 is equal to voltage Vr, and voltage Vi4 is equal to voltage (Va+Vset2) obtained by superimposing voltage Vset2 to negative voltage Va. In this drawing, also regarding input signals CEL1 and CEL2 to AND gate AG, “1” and “0” are represented as “Hi” and “Lo”, respectively.

FIG. 8 shows operation in time period T8 and time period T9 when the erasing ramp voltage is generated in order to show the difference between the generation of the erasing ramp voltage and the generation of the up-ramp voltage.

In order to set voltage Vi4 at voltage (Va+Vset2) obtained by superimposing voltage Vset2 to negative voltage Va, switching signal CEL2 is kept at “1” in time period T10 through time period T14. In time period T10 through time period T14, switching element Q21 is kept at OFF (not shown). A signal of a polarity reverse to that of the signal to be input to input terminal INa is input to switching element Q12 forming a separating circuit, and a signal of a polarity reverse to that of the signal to be input to input terminal INb is input to switching element Q13 forming a separating circuit (not shown).

(Time Period T8)

Input terminal INc is set at “Hi” in time period T8. Constant current flows from resistor R12 toward capacitor C11, the source voltage of switching element Q15 increases like a ramp, and the output voltage of scan electrode driving circuit 43 starts to increase like a ramp more sharply than the up-ramp voltage.

(Time Period T9)

The driving voltage waveform output from initializing waveform generating circuit 53 reaches voltage Vers, switching element Q16 becomes ON, current input to input terminal INc in order to operate second Miller integrating circuit 56 is extracted by switching element Q16, and second Miller integrating circuit 56 stops operating.

Thus, erasing ramp voltage as the second ramp voltage that increases from 0 (V) as the base potential to voltage Vers is generated.

(Time Period T10)

Switching element Q1 of sustain pulse generating circuit 50 is set at ON. Then, inter-electrode capacity Cp resonates with inductor L1, and current starts to flow from capacitor C1 for recovering electric power through switching element Q1, diode D1, and inductor L1, and the voltage of scan electrode SC1 through scan electrode SCn starts to increase.

(Time Period T11)

Next, switching element Q3 of sustain pulse generating circuit 50 is set at ON. Then, voltage Vs is applied to scan electrode SC1 through scan electrode SCn via switching element Q3 and switching element Q12, and the potential of scan electrode SC1 through scan electrode SCn becomes voltage Vs (equal to Vi1 in the present embodiment).

(Time Period T12)

Next, input terminal INa of the Miller integrating circuit for generating up-ramp voltage is set at “Hi”. Specifically, a predetermined constant current is input to input terminal INa. Then, constant current flows from resistor R10 toward capacitor C10, the source voltage of switching element Q11 increases like a ramp, and the output voltage of scan electrode driving circuit 43 also starts to increase like a ramp. This voltage increase continues while input terminal INa is at “Hi”.

After the output voltage increases to voltage Vr (equal to Vi2 in the present embodiment), input terminal INa is set at “Lo”. Specifically, for example, voltage 0 (V) is applied to input terminal INa.

Thus, the up-ramp voltage gradually increases from voltage Vs, which is not higher than the discharge start voltage, to voltage Vr, which is higher than the discharge start voltage, is applied to scan electrode SC1 through scan electrode SCn. Here, voltage Vs is equal to Vi1, and voltage Vr is equal to Vi2 in the present embodiment.

(Time Period T13)

When input terminal INa is set at “Lo”, the voltage of scan electrode SC1 through scan electrode SCn decreases to voltage Vs (equal to Vi3 in the present embodiment). Then, switching element Q3 is set at OFF.

(Time Period T14)

Next, input terminal INb of the Miller integrating circuit for generating down-ramp voltage is set at “Hi”. Specifically, for example, voltage 15 (V) is applied to input terminal INb. Then, constant current flows from resistor R11 toward capacitor C12, the drain voltage of switching element Q14 decreases like a ramp, and the output voltage of scan electrode driving circuit 43 also starts to decrease like a ramp. Just before the initializing period finishes, input terminal INb is set at “Lo”. Specifically, for example, voltage 0 (V) is applied to input terminal INb.

Switching element Q13 becomes OFF in time period T14, but the Miller integrating circuit for generating down-ramp voltage can decrease the output voltage of scan electrode driving circuit 43 via a body diode of switching element Q13.

Comparator CP compares the down-ramp voltage with voltage (Va+Vset2) obtained by adding voltage Vset2 to voltage Va. The output signal from comparator CP is switched from “0” to “1” at time t14 when the down-ramp voltage becomes voltage (Va+Vset2) or lower. Switching signal CEL2 is “1”, so that both inputs of AND gate AG are “1”. Therefore, “1” is output from AND gate AG, and voltage Vc obtained by superimposing voltage Vscn on negative voltage Va is output from scan pulse generating circuit 54. Therefore, the down-ramp voltage is output from scan pulse generating circuit 54 while voltage Vi4 is set at (Va+Vset2).

Thus, scan electrode driving circuit 43 generates the up-ramp voltage as the first ramp voltage, applies it to scan electrode SC1 through scan electrode SCn, and then applies the down-ramp voltage. Here, the up-ramp voltage gradually increases from voltage Vi1, which is not higher than the discharge start voltage, to voltage Vi2, which is higher than the discharge start voltage. The down-ramp voltage gradually decreases from voltage Vi3 to voltage Vi4.

After the initializing period, switching element Q21 is kept at ON in the subsequent address period (not shown). The voltage input to one terminal of comparator CP thus becomes negative voltage Va, and output signal CEL1 from comparator CP is kept at “1”. Thus, the output from AND gate AG is kept at “1”, and voltage Vc obtained by superimposing voltage Vscn on negative voltage Va is output from scan pulse generating circuit 54. When switching signal CEL2 is set at “0” at the timing of generating negative scan pulse voltage, the output signal of AND gate AG becomes “0” and negative voltage Va is output from scan pulse generating circuit 54. Thus, negative scan pulse voltage in the address period can be generated.

As described above, in the present embodiment, at the end of the sustain period, namely after the sustain pulse is completed to be applied to the display electrode pair, the erasing ramp voltage whose gradient is steeper than that of the up-ramp voltage is applied to scan electrode SC1 through scan electrode SCn to continuously generate feeble erasing discharge. Immediately after the increasing voltage reaches voltage Vers, the voltage is dropped to 0 (V) as the base potential. Thanks to this structure, the priming particles generated by the erasing discharge are immediately converged, hence the wall charge can be put into a stabler state, and the subsequent initializing discharge, especially the initializing discharge by the selection initializing operation using the down-ramp voltage, can be stably caused. Even in the panel of large screen size and high definition, address discharge can be stably caused without increasing the voltage required for causing the address discharge, so that occurrence of an operation failure during address can be reduced and the image display quality can be improved.

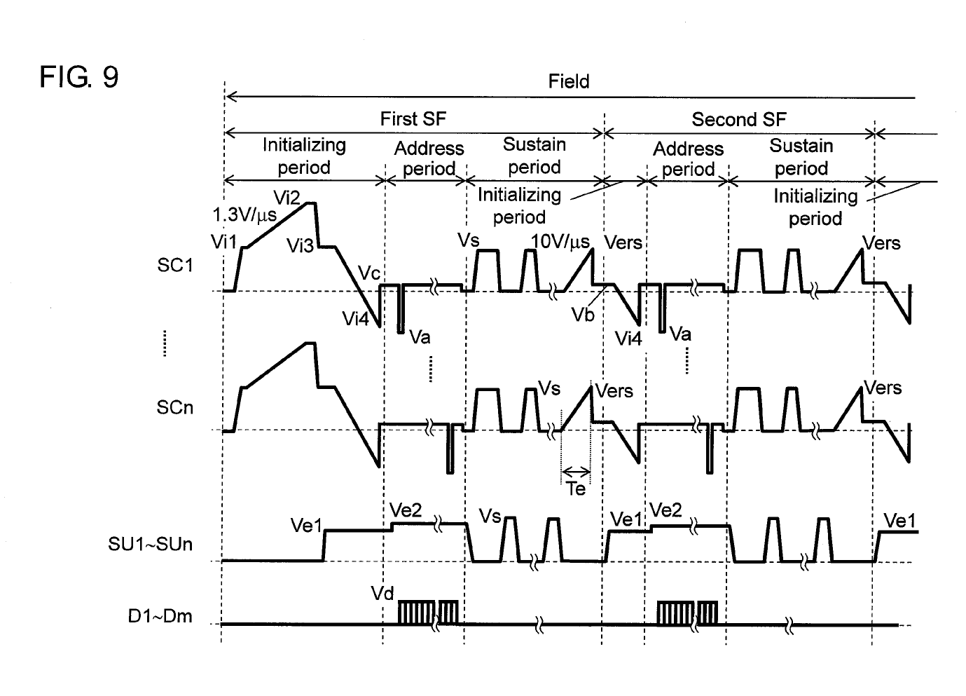

In the present embodiment, the erasing ramp voltage has been described in which, the voltage is increased and is dropped to 0 (V) as the base potential immediately after reaching voltage Vers. In order to prevent the above-mentioned abnormal discharge, preferably, the arrival voltage after the drop is set at 70% or lower of voltage Vers. FIG. 9 shows another example of the driving voltage waveform in accordance with the exemplary embodiment of the present invention. For example, in FIG. 9, immediately after the erasing ramp voltage reaches voltage Vers, the voltage is dropped to voltage Vb (the value of voltage Vb is voltage Vers×0.7 or lower). In this structure, even when voltage Vb is kept for a certain period after that, the above-mentioned abnormal discharge is prevented and the above-mentioned effect can be obtained. In the present embodiment, the lower limit voltage value of the arrival voltage after the drop is set at 0 (V) as the base potential. However, this lower limit voltage value is simply a value set for smoothly performing the subsequent selection initializing operation using the down-ramp voltage. In the present embodiment, the lower limit voltage value is not limited to the above-mentioned value, and is required to be set optimally as long as the operation following the erasing operation can be smoothly performed.

In the present embodiment, a first ramp waveform generating circuit for generating up-ramp voltage during initializing operation and a second ramp waveform generating circuit for generating erasing ramp voltage are disposed mutually independently. However, the present invention is not limited to this structure. Both of the up-ramp voltage and erasing ramp voltage are applied to scan electrode SC1 through scan electrode SCn. Therefore, when one ramp waveform generating circuit (Miller integrating circuit or the like) is configured so that the gradient and maximum voltage value of the generated ramp waveform can be varied using a switching element or the like, the first ramp waveform generating circuit and the second ramp waveform generating circuit can be formed of a common circuit.

In the present embodiment, scan electrode driving circuit 43 and sustain electrode driving circuit 44 shown in FIG. 5 and FIG. 6 are simply one configuration example, and any circuitry may be employed as long as it can achieve a similar operation. For example, the circuit for applying voltage Ve1 and voltage Ve2 is not limited to the circuit shown in FIG. 6. This circuit may have a configuration that has a power supply for generating voltage Ve1, a power supply for generating voltage Ve2, and a plurality of switching elements for applying respective voltages to sustain electrode SU1 through sustain electrode SUn, and applies respective voltages to sustain electrode SU1 through sustain electrode SUn with a required timing. The circuit for applying erasing ramp voltage shown in FIG. 5 is also simply one configuration example, and may be replaced with another circuit capable of achieving a similar operation.

The present embodiment can be applied to a driving method of a panel by the so-called two-layer driving. This two-layer driving means the following driving method, for example. Scan electrode SC1 through scan electrode SCn are firstly divided into a first scan electrode group and a second scan electrode group. The address period is then formed of a first address period when scan pulses are sequentially applied to respective scan electrodes belonging to the first scan electrode group and a second address period when scan pulses are sequentially applied to respective scan electrodes belonging to the second scan electrode group. In at least one of the first scan electrode group and the second scan electrode group, scan pulses whose voltage varies from the second voltage higher than the scan pulse voltage to the scan pulse voltage and returns to the second voltage again are sequentially applied to the scan electrodes belonging to the scan electrode group that is to be applied with scan pulses. One of the third voltage higher than the scan pulse voltage and the fourth voltage higher than the second voltage and the third voltage is applied to the scan electrodes belonging to the scan electrode group that is not to be applied with scan pulses. While the scan pulse voltage is applied to at least adjacent scan electrode, the third voltage is applied to these scan electrodes. Even in such a pulse driving method, an effect similar to the above-mentioned effect can be produced by applying the present embodiment.

In the present invention, the erasing ramp voltage is applied to scan electrode SC1 through scan electrode SCn. While, there is a conventional art where electrodes to be applied with the last sustain pulse are set as scan electrode SC1 through scan electrode SCn, and the erasing ramp voltage is applied to sustain electrode SU1 through sustain electrode SUn. It is recognized that setting the number of sustain pulses generated in one sustain period to be even rather than odd can improve the gradation and the image quality of the display image. When the number of sustain pulses generated in one sustain period is even, the sustain pulse generated at the end of the sustain period is applied to sustain electrode SU1 through sustain electrode SUn. In other words, the present invention can produce more preferable effect also from the viewpoint of image quality. In the conventional art where the erasing ramp voltage is applied to sustain electrode SU1 through sustain electrode SUn, a waveform similar to that in the all-cell initializing operation shown in the present embodiment, namely the initializing waveform having an up-ramp waveform, must be applied to scan electrode SC1 through scan electrode SCn after the erasing ramp voltage is generated. While, the erasing ramp voltage is applied to scan electrode SC1 through scan electrode SCn in the present invention, so that the initializing operation can be performed in the selection initializing subfield by applying the above-mentioned down-ramp voltage to scan electrode SC1 through scan electrode SCn. A more preferable effect can be produced also from the viewpoint of time required for the initializing operation.

In the present embodiment, electric power recovering circuit 51 and electric power recovering circuit 61 use one common inductor in raising and falling a sustain pulse. However, the configuration may be employed where a plurality of inductors are used, namely different inductors are used in raising and falling the sustain pulse.

Specific numerical values, such as the voltage value of voltage Vers and the gradient of the erasing ramp voltage, shown in the present embodiment are simply one example, and are set based on the characteristic of a 42-inch panel with 1080 display electrode pairs used in the experiment. The present embodiment is not limited to these numerical values, and the numerical values are preferably set at optimal values in response to the characteristic of the panel and the specification of the plasma display device. These numerical values allow dispersion within a range for producing the above-mentioned effect.

### INDUSTRIAL APPLICABILITY

In the present invention, the erasing ramp voltage, which is up-ramp voltage for erasing discharge to be applied to a scan electrode at the end of a sustain period, is increased, and is decreased immediately after reaching voltage Vers. Therefore, even in a panel of large screen size and high definition, stable address discharge can be caused without increasing the applied voltage required for generating address discharge. The present invention is useful as a plasma display device and a driving method of a panel that can improve the image display quality by reducing the occurrence of an operation failure during address.

1. A plasma display device comprising:
a plasma display panel having a plurality of discharge cells, each of the discharge cells having a display electrode pair that includes a scan electrode and a sustain electrode,
wherein a plurality of subfields are set in one field period, the subfields having an initializing period, an address period, and a sustain period; and
the scan electrode driving circuit generating an increasing first ramp voltage in the initializing period of at least one subfield in the one field period,
the scan electrode driving circuit generating sustain pulse voltage in the sustain period, the sustain pulse voltage varying from a base potential to a potential for generating sustain discharge,
the scan electrode driving circuit generating a second ramp voltage at an end of the sustain period, the second ramp voltage being increased and being dropped immediately after the second ramp voltage reaches a predetermined potential.

2. The plasma display device of claim 1, wherein
the scan electrode driving circuit generates the second ramp voltage in a gradient steeper than that of the first ramp voltage.

3. The plasma display device of claim 1, wherein
the scan electrode driving circuit generates the second ramp voltage while the predetermined potential is set between the sustain pulse voltage −10 (V) and the sustain pulse voltage +10 (V) inclusive.

4. The plasma display device of claim 1, wherein
the scan electrode driving circuit generates the second ramp voltage in a gradient of 2 V/μsec through 20 V/μsec.

5. A driving method of a plasma display panel, the plasma display panel having a plurality of discharge cells, each of the discharge cells having a display electrode pair that includes a scan electrode and a sustain electrode,
wherein a plurality of subfields are set in one field period, the subfields having an initializing period, an address period, and a sustain period,
the method comprising:
applying an increasing first ramp voltage to the scan electrode in the initializing period of at least one subfield in the one field period;
alternately applying sustain pulse voltage to the display electrode pair and driving the plasma display panel in the sustain period, the sustain pulse voltage varying from a base potential to a potential for generating sustain discharge; and
applying a second ramp voltage at the end of the sustain period, the second ramp voltage being increased and being dropped immediately after reaching a predetermined potential.

6. The driving method of the plasma display panel of claim 5, wherein
the second ramp voltage is generated in a gradient steeper than that of the first ramp voltage.
